(19) United States
(12) Patent Application Publication
(10) Pub. No.: US 2025/0078059 A1
(43) Pub. Date: Mar. 6, 2025

(54) POINT OF SALE TERMINAL, METHOD, AND MEDIUM

(71) Applicant: Toshiba Tec Kabushiki Kaisha, Tokyo (JP)

(72) Inventor: Masachika KURATA, Sunto Shizuoka (JP)

(21) Appl. No.: 18/645,296

(22) Filed: Apr. 24, 2024

(30) Foreign Application Priority Data
Sep. 1, 2023 (JP) 2023-142173

(51) Int. Cl. G06Q 20/20

(52) U.S. Cl. CPC G06Q 20/208

(57) ABSTRACT

A self-service POS terminal includes a tag reader, a camera, and a processor configured to: start a registration process to register items each of which has a wireless tag attached thereto, control the wireless tag reader to read tag information from wireless tags and store the tag information in memory, determine a number of the tags based on the tag information, control the camera to capture images and generate image data from each of the images, perform object recognition on the image data to determine a number of items shown in the images, compare the number of the tags with the number of the items, when the number of the tags is identical to the number of the items, perform a checkout process, and when the number of the tags is not identical to the number of the items, issue a notification signal.

### CROSS-REFERENCE TO RELATED APPLICATION

This application is based upon and claims the benefit of priority from Japanese Patent Application No. 2023-142173, filed Sep. 1, 2023, the entire contents of which are incorporated herein by reference.

### FIELD

Embodiments described herein relate generally to a point of sale (POS) terminal, a method, and a medium.

### BACKGROUND

In recent years, in a retail store such as a clothing retailer or a supermarket, a wireless tag system has been adopted in which a wireless tag is attached to an item sold at the store, and information related to the item is read by a wireless tag reader when a customer purchases the item. The wireless tag reader reads the tag information using a radio frequency identification (RFID) technique (hereinafter, the wireless tag is also referred to as an RFID tag). The item purchased by the customer is, for example, put into a basket and brought to a checkout counter. The RFID tag reading apparatus provided at the checkout counter reads the tag information from the RFID tag by communicating with the wireless tag of the item stored in the basket via an antenna.

The tag information read by the RFID tag reading apparatus (e.g., an item code for identifying an item) is transmitted to a POS terminal. The POS terminal performs a checkout process based on the received item information. The checkout process is a process for paying the price of the item purchased by a customer. The POS terminal is a conventional POS terminal operated by a store clerk, a self-service POS terminal operated by a customer himself/herself, or the like.

Incidentally, the RFID tag reading apparatus may not be able to read tag information from an RFID tag properly due to its position and orientation, an overlap with the item, or the like (hereinafter referred to as “reading omission”) or may read tag information from an unrelated RFID tag located nearby. Therefore, conventionally, there has been proposed a configuration in which an antenna capable of communicating with a wireless tag is embedded in an area where a basket is placed and an area where an item is bagged, and when an item is taken out from the basket is moved to the area where the item is bagged, the wireless tag of the item is read for registration.

However, even in the above-described conventional method, there is a possibility that reading omission or unnecessary detection may occur depending on the position and orientation of the RFID tag. In addition, since the RFID tag is automatically read, it is difficult for customers to know which tag is erroneously read or not read when unread or erroneous reading occurs.

### SUMMARY OF THE INVENTION

The present disclosure relates to an item sales data processing apparatus, and more particularly, to an item sales data processing apparatus and a program that can easily recognize that an RFID tag is missing or read improperly.

In one embodiment, a self-service point of sale (POS) terminal comprises a wireless tag reader; a camera; a memory; and a processor configured to: start a registration process to register items each of which has a wireless tag attached thereto, control the wireless tag reader to read tag information from one or more wireless tags and store the tag information in the memory, determine a number of the wireless tags based on the stored tag information, control the camera to capture one or more images and generate image data from each of the images, perform object recognition on the image data to determine a number of items shown in the images, compare the number of the wireless tags with the number of the items, when the number of the wireless tags is identical to the number of the items, perform a checkout process, and when the number of the wireless tags is not identical to the number of the items, issue a notification signal.

### BRIEF DESCRIPTION OF THE DRAWINGS

FIG. 1 is an external perspective view illustrating a configuration of a self-service POS terminal according to an embodiment.

FIG. 2 is a diagram illustrating a hardware configuration of the self-service POS terminal.

FIG. 3 is a diagram illustrating a functional configuration of the self-service POS terminal.

FIG. 4 is a diagram illustrating exemplary images analyzed by the self-service POS terminal.

FIG. 5 is a diagram illustrating exemplary images analyzed by the self-service POS terminal.

FIG. 6 is a diagram illustrating exemplary images analyzed by the self-service POS terminal.

FIG. 7 is a diagram illustrating exemplary images analyzed by the self-service POS terminal.

FIG. 8 is a diagram illustrating exemplary images analyzed by the self-service POS terminal.

FIG. 9 is a flowchart illustrating an exemplary item data process performed by the self-service POS terminal.

FIG. 10 is a flowchart illustrating an example of a counting process related to item movement according to an embodiment.

### DETAILED DESCRIPTION

Hereinafter, embodiments of this disclosure will be described with reference to the drawings. In the embodiments described below, as an example of an item data processing apparatus, a self-service POS terminal in which customers perform a registering operation and a checkout operation will be described. However, the present invention is not limited to the embodiments described below.

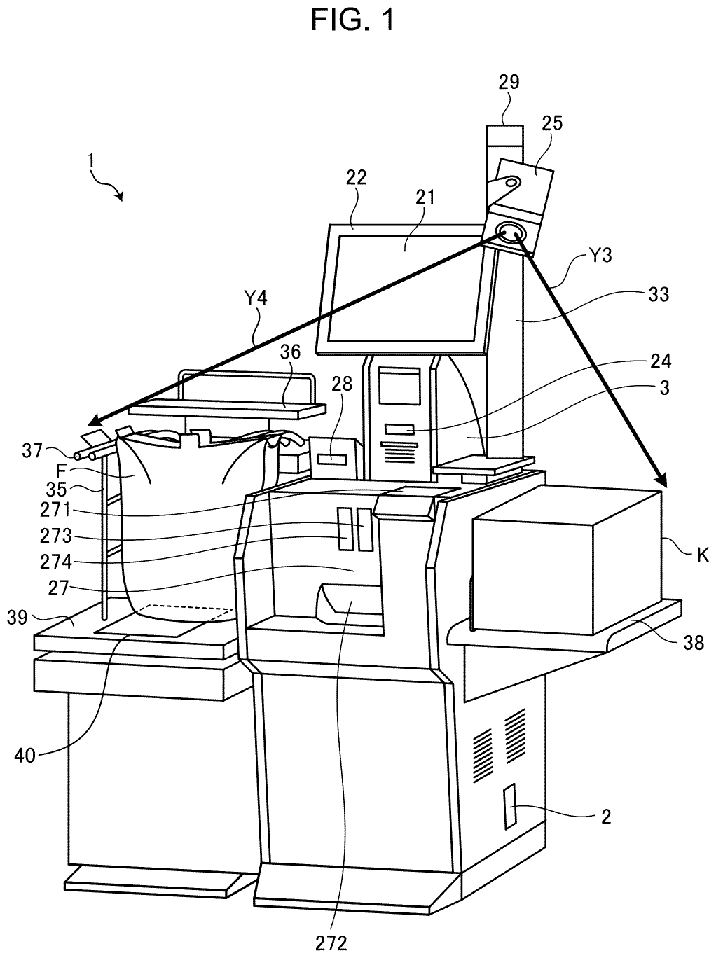

FIG. 1 is an external perspective view illustrating a configuration of a self-service POS terminal 1 according to an embodiment. The self-service POS terminal 1 is an exemplary item sales data processing apparatus, and is used in a store such as a supermarket. As illustrated in FIG. 1, the self-service POS terminal 1 includes a reading unit that reads an RFID tag for specifying an item to be purchased, and a checkout unit for a checkout operation based on the item information corresponding to the read RFID tag. Note that the checkout operation is performed by the customer himself/herself. Then, the self-service POS terminal 1 executes a sales registration process based on the item information corresponding to the RFID tag read by the reading unit. Further, the self-service POS terminal 1 executes a checkout process based on the checkout operation performed by the customer.

Here, the sales registration process refers to a process of displaying and storing item information such as an item name and a price of the item based on the input item code. In addition, the checkout process refers to a process of displaying a total amount related to a transaction and issuing a receipt based on the item information subjected to the sales registration process, and a checkout processing of issuing a receipt based on the deposit deposited from the customer. The transaction process includes a sales registration process and a checkout process. The transaction information includes item information and accounting information.

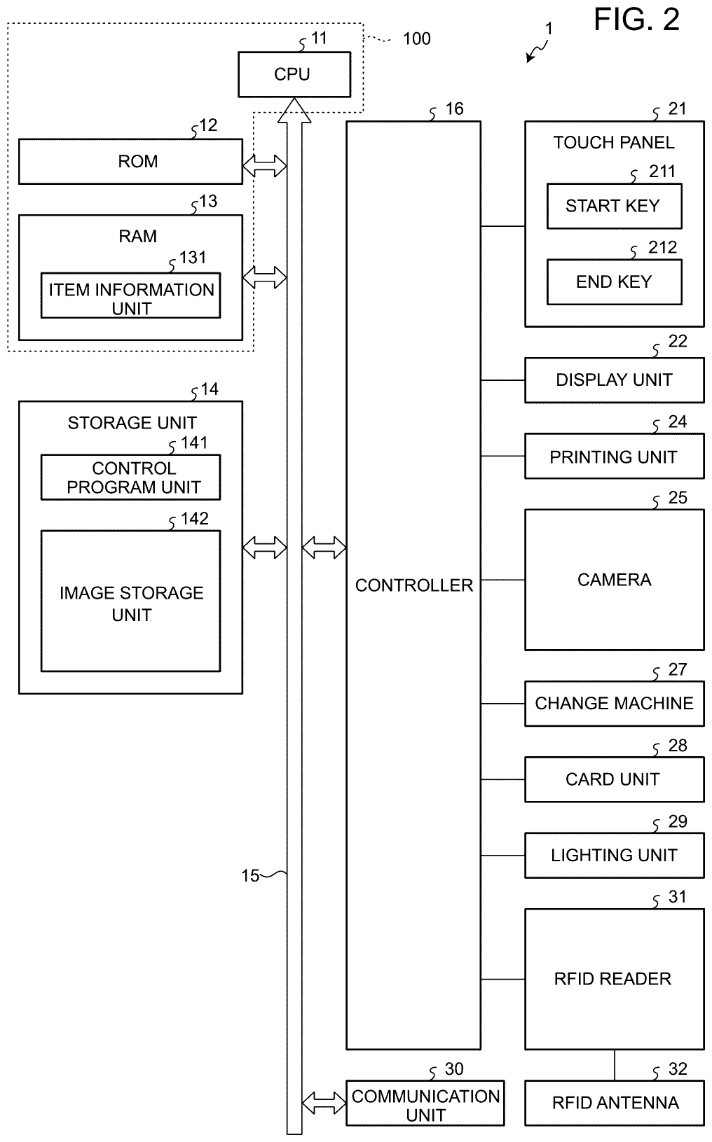

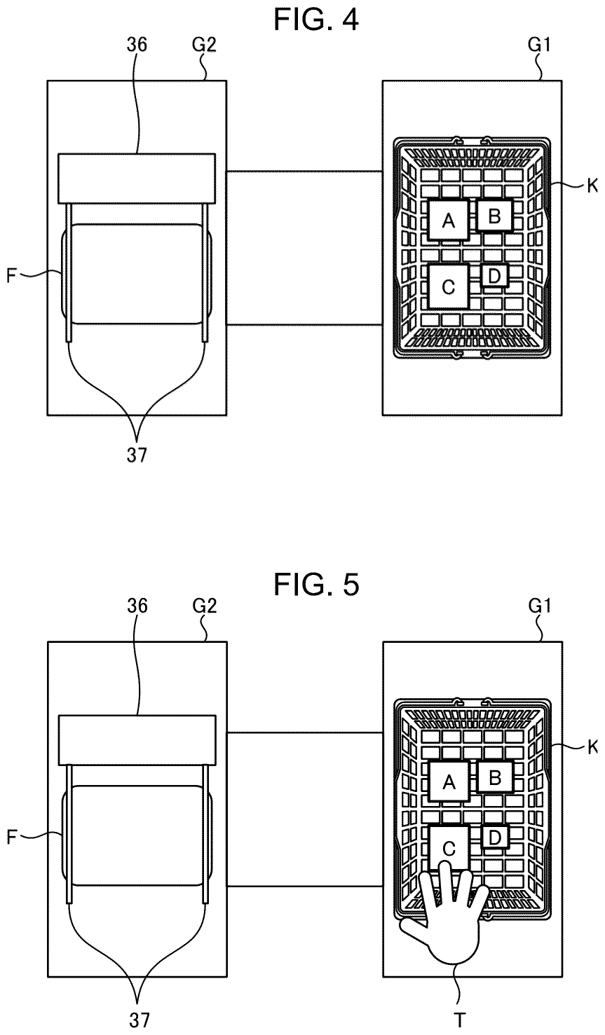

The self-service POS terminal 1 includes a first housing 2 and a second housing 3. The first housing 2 houses therein a change machine 27 and a control device (not shown) functioning as a coin change machine or a bill change machine. The change machine 27 stores the money deposited by the customer. The change machine 27 also dispenses the change to the customer. The control device executes a control process of the self-service POS terminal 1 (see FIG. 4). The control device includes a control unit 100, a storage unit 14, a communication unit 30, a power supply unit (not shown), and the like in FIG. 2.

The first housing 2 includes a deposit port 271 for depositing coins into the change machine 27, and a dispensing port 272 for dispensing coins from the change machine 27. Further, the first housing 2 includes a deposit port 273 for depositing bills into the change machine 27, and a dispensing port 274 for dispensing bills from the change machine 27. As a checkout operation, the customer deposits coins out of the purchase price of the item into the deposit port 271, and deposits the bills out of the payment into the deposit port 273. The self-service POS terminal 1 takes the received money into the change machine 27 and stores the money in the storage unit according to the denomination. Further, the self-service POS terminal 1 pays out the change for the coin from the change machine 27 to the dispensing port 272 among the changes to be paid to the customers. Further, the self-service POS terminal 1 pays out the change for the bill from the change machine 27 to the dispensing port 274 among the changes to be paid to the customers.

Further, the first housing 2 includes a basket placing table 38 and a shopping bag table 39 on the left and right side surfaces. The basket placing table 38 provided on the right side surface of the first housing 2 is a table on which a basket K into which an item for purchase is put is placed. The shopping bag table 39 provided on the left side surface of the first housing 2 is a table on which a shopping bag F for filling the item taken out from the basket placing table 38 into the shopping bag F is set. The item packed in the shopping bag F is placed on the shopping bag table 39.

The shopping bag table 39 includes two supports 35 extending upward from the upper surface of the shopping bag table 39, a temporary placing table 36 formed flat on the upper portion of the support 35, and two extension bars 37 extending substantially horizontally from the temporary placing table 36. The extension bar 37 is a bar for hooking the shopping bag F on the vinyl to be packed with the item. The shopping bag F is set on the shopping bag base 39 in a state of being opened in a state where the handle is hooked on the extension bar 37, and the item is easily inserted. The temporary placing table 36 is a table on which fragile items (e.g., tofu and eggs) are temporarily placed. The items placed on the temporary placing table 36 are finally packed in the shopping bags F.

The upper surface of the shopping bag table 39 serves as a shopping bag placing area 40, and the item stored in the shopping bag F is placed. An RFID antenna 32 (not shown in FIG. 1) is installed below the shopping bag placing area 40. As will be described later, the RFID antenna 32 is connected to an RFID reader 31, and the RFID reader 31 radiates radio waves via the RFID antenna 32. The RFID reader 31 reads RFID signal received by the RFID antenna 32.

The second housing 3 is provided at an upper portion of the first housing 2. The second housing 3 accommodates a printing unit 24 therein. The printing unit 24 includes, for example, a thermal head, and prints transaction information of an item purchased by a customer to issue a receipt. In addition, the self-service POS terminal 1 includes a card unit 28 on a side of the second housing 3 on the upper surface of the first housing 2. The card unit 28 reads the customer identification information from the inserted credit card, for example. The self-service POS terminal 1 executes a checkout process based on the customer identification information read by the card unit 28.

The second housing 3 includes a display unit 22 at an upper portion thereof. The display unit 22 functions as a commercial control unit to be described later. The display unit 22 displays the item information of the item registered for sales in accordance with the registration operation by the customer. Further, the display unit 22 displays accounting information associated with the checkout operation by the customer. The display unit 22 is arranged with a display surface 51 facing a customer who operates the self-service POS terminal 1. The display unit 22 includes a touch panel 21 on the display surface 51. The displayed key functions by operating the touch panel 21 at a position corresponding to the key displayed on the display unit 22.

Further, the self-service POS terminal 1 is provided with a cylindrical pole 33 extending upward from the upper surface of the first housing 2 behind the second housing 3. The upper end portion of the pole 33 is provided with a lighting unit 29 that emits light when a customer performs an operation of calling an attendant or the like. In addition, the self-service POS terminal 1 includes a camera 25 immediately below the lighting unit 29 of the pole 33. The camera 25 captures an image of a wide range from the arrow Y3 to the arrow Y4, that is, a range from the basket placing table 38 to the shopping bag table 39. The camera 25 is capable of shooting an image of an operation in which the customer takes out the item contained in the basket K from the basket K and an operation in which the item taken out by the customer is bagged in the shopping bag F. Here, the shooting means that the camera 25 captures a moving image or a still image continuously.

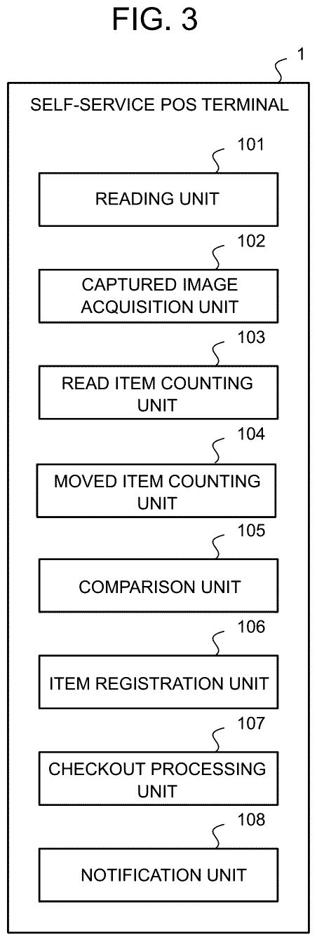

Note that the moved item counting unit 104, which will be described later (see FIG. 3), distinguishes and recognizes the items contained in the basket K. This technique is called “contour extraction” or “edge extraction”, and is a known technique for recognizing, as a contour or edge, a change in color or density of an object and another object, or an object and a background (e.g., a basket K) based on a captured image. The control unit 100 continuously labels the contour to recognize an object surrounded by the contour as one item and distinguish it from another item. In this way, the control unit 100 distinguishes the items inserted into the basket K. Hereinafter, the above-described technique is referred to as “labeling”.

Further, the moved item counting unit 104 recognizes the movement of the operator who operates the own device from the image captured by the camera 25, and recognizes that the registration operation for registering the item has been performed when the operation of moving the item classified by labeling from the basket placing table 38 (i.e., the basket K) to the shopping bag table 39 (i.e., the shopping bag F) is performed.

Here, a hardware configuration of the self-service POS terminal 1 will be described. FIG. 2 is a diagram illustrating a hardware configuration of the self-service POS terminal 1. As illustrated in FIG. 2, the self-service POS terminal 1 includes a central processing unit (CPU) 11, a read only memory (ROM) 12, a random access memory (RAM) 13, a storage unit 14, and the like. The CPU 11 is a processor. The ROM 12 stores various programs. The RAM 13 stores various types of data. The storage unit 14 stores various programs. The CPU 11, the ROM 12, the RAM 13, and the storage unit 14 are connected to each other via a data bus 15. The CPU 11, the ROM 12, the RAM 13 constitute the control unit 100. That is, the control unit 100 executes a control process to be described later in accordance with a control program stored in the ROM 12 or the storage unit 14 and loaded in the RAM 13.

The storage unit 14 includes a non-volatile memory such as a hard disc drive (HDD) and a flash memory for holding storage information even when the power is turned off, and includes a control program unit 141 for storing the control program. The storage unit 14 includes an image storage unit 142. The image storage unit 142 stores an image captured by the camera 25.

The control unit 100 is connected to the touch panel 21, the display unit 22, the printing unit 24, the camera 25, the change machine 27, the card unit 28, the lightning unit 29, the communication unit 30, the RFID reader 31, and the RFID antenna 32 via the data bus 15 and a controller 16.

The touch panel 21 includes a start key 211 corresponding to the display of the “start key” of the display unit 22 and an end key 212 corresponding to the display of the “end key”. In the following description, the “key provided on the touch panel 21 corresponding to the display of the key of the display unit 22” will be described in a simplified manner, for example, as the “key displayed on the display unit 22”.

The start key 211 is a key operated by the customer when the registration operation by the customer is started in the self-service POS terminal 1. The end key 212 is operated by the customer when the registration operation by the customer is terminated in the self-service POS terminal 1.

The display unit 22 is constituted by, for example, a liquid crystal panel (LCD). Each of the cameras 25 includes a CCD image sensor (not shown) for capturing images.

The RFID reader 31 radiates radio waves from the RFID antenna 32. Further, the RFID reader 31 acquires tag information from an RFID tag via the RFID antenna 32, and outputs the tag information to the self-service POS terminal 1.

The functional configuration of the self-service POS terminal 1 will now be described. FIG. 3 is a diagram illustrating an exemplary functional configuration of the self-service POS terminal 1. As illustrated in FIG. 3, the self-service POS terminal 1 includes a reading unit 101, a captured image acquisition unit 102, a read item counting unit 103, the moved item counting unit 104, a comparison unit 105, an item registration unit 106, a checkout processing unit 107, and a notification unit 108. Some or all of these functional units may be software executed by the CPU 11 according to various programs stored in the ROM 12 and the storage unit 14. In addition, some or all of these functional units may be performed by hardware such as a dedicated circuit or the like.

The reading unit 101 controls the RFID reader 31 to read tag information using the RFID antenna 32. Specifically, the reading unit 101 controls the RFID reader 31 and causes the RFID antenna 32 to transmit radio waves for communicating with an RFID tag. In addition, the reading unit 101 acquires the tag information received by the RFID antenna 32 via the RFID reader 31.

The captured image acquisition unit 102 acquires a video or a continuous still image (hereinafter, also simply referred to as an image) obtained by capturing an image of an operator who operates the self-service POS terminal 1 by the camera 25. Specifically, the captured image acquisition unit 102 starts capturing a video or a continuous still image captured by the camera 25 via the controller 16. Further, the captured image acquisition unit 102 stores the image captured by the camera 25 in the image storage unit 142 of the storage unit 14.

The read item counting unit 103 counts the number of items to be purchased by the customers, that is, the number of the RFID tags received by the RFID antenna 32. Specifically, the read item counting unit 103 counts the number of items read by the reading unit 101 (hereinafter, also referred to as the read item number).

In order to prevent same tag information from being read two or more times, the read item count unit 103 performs an exclusion process using tag identifiers. For example, the read item counting unit 103 temporarily stores each tag identifier in association with tag information that has been read and counted so as not to count the same tag information again.

Further, the read item counting unit 103 may be configured to count the numbers of the items registered by the item registration unit 106 described later. In this case, the read item count unit 103 may use the exclusive function of the duplicate registration included in the item registration unit 106.

The moved item counting unit 104 counts the number of the items that have been moved to the transmission range of the radio wave from the operation of the operator represented in the image on the basis of the video or the continuous still image obtained by shooting the operator who operates the own device by the camera 25. Specifically, when the moved item counting unit 104 analyzes the image stored in the image storage unit 142 and recognizes that a registration operation has been performed in which the item moves from the basket placing table 38 (i.e., the basket K) to the shopping bag table 39 (i.e., the shopping bag F), the moved item counting unit 104 counts the number of moved items (hereinafter, also referred to as the moved item number). The operation of the moved item counting unit 104 will be described later.

The comparison unit 105 compares the number of the items read by the RFID antenna 32 installed below the shopping bag table 39 with the number of the items moved from the basket K to the shopping bag F, and outputs a comparison result. Specifically, the comparison unit 105 compares the read item number counted by the read item counting unit 103 with the moved item number counted by the moved item counting unit 104.

The item registration unit 106 performs sales registration of items purchased by customers based on the tag information read by the RFID antenna 32 and acquired by the reading unit 101. Specifically, the item registration unit 106 obtains the item information of the item corresponding to the item code included in the tag information by collating the item code included in the tag information with the item code of each item stored in the storage unit 14. Then, the item registration unit 106 performs sales registration of the item by temporarily storing the acquired item information in the RAM 13 or the like.

It is assumed that the item registration unit 106 performs the exclusive process based on the tag identifiers in order to prevent the item code included in the same tag information from being registered for sales two or more times. For example, the item registration unit 106 performs sales registration on the tag identifiers of the tag information used for acquiring the item information together with the item information, thereby controlling the item information related to the same tag identifier not to be registered in duplicate.

The checkout processing unit 107 performs a checkout process for an item purchased by the customer based on the item information registered by the item registration unit 106 for sales. For example, the checkout processing unit 107 calculates the total amount of the item based on the price included in the item information of each item registered by the item registration unit 106. Further, the checkout processing unit 107 subtracts the total price from the received payment amount, and causes the subtracted value (i.e., the change amount) to be discharged as change.

The notification unit 108 performs notification to the customer or the store clerk based on the comparison result of the comparison unit 105. Specifically, when the comparison result of the number of read items and the number of moved items by the comparison unit 105 is inconsistent, the notification unit 108 notifies the customer or the store clerk by controlling the display unit 22 to display a message indicating that the number of the items does not match.

In addition, as another method of the notification, the notification unit 108 may control the lighting unit 29 to emit light, thereby notifying the store clerk.

Further, a threshold value may be set in advance for the difference between the number of read items and the number of the moved items, and the notification method or the content of the message to be notified may be changed according to whether or not the difference is equal to or larger than the threshold value. For example, in a case where the difference is less than the threshold value, a message may be displayed on the display unit 22 to prompt confirmation of whether or not the items packed in the shopping bags F are overlapped multiple times, assuming the possibility of the reading failure of the tag due to the overlapping of the items. In addition, when the difference is equal to or larger than the threshold value, the guidance of the item movement method may be displayed on the display unit 22 on the assumption that the item movement is not correctly recognized. Alternatively, the notification may be made to the store clerk by causing the lighting unit 29 to emit light.

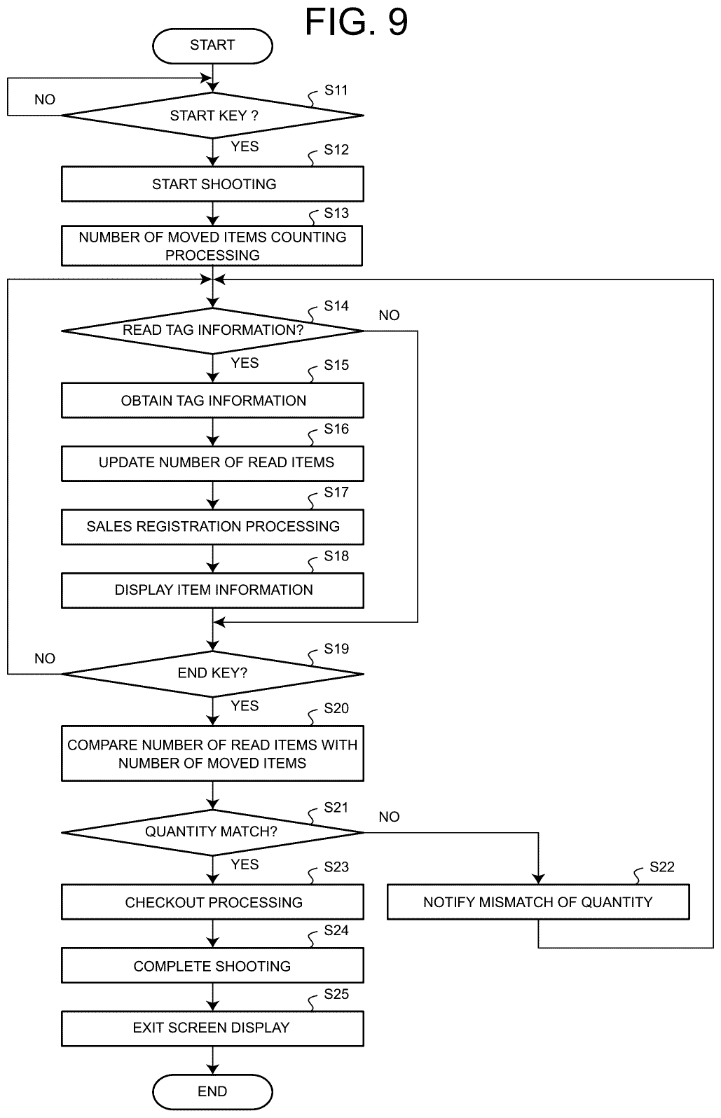

As described later with reference to FIG. 9, the timing at which the notification is performed may be a timing at which the end key 212 is operated. Alternatively, a timing at which a difference equal to or larger than a threshold value set in advance between the number of read items and number of moved items occurs during the registration operation may be used.

In addition, as a case in which the number of items does not match, a case in which the number of moved items is larger than the number of read items is assumed. This is, for example, a case in which the RFID tag of an item cannot be read by placing the item on the temporary placing table 36 when the item is moved. Therefore, as a result of the comparison by the comparison unit 105, when the number of moved items becomes larger than the number of read items, the notification unit 108 may control the display unit 22 to display a message for prompting confirmation that the item is not placed on the temporary placing table 36 in addition to the message indicating that the numbers of the items do not match.

Hereinafter, an operation example of the read item counting unit 103 and the moved item counting unit 104 will be described with reference to FIGS. 4 to 8. Here, FIGS. 4 to 8 are diagrams schematically illustrating images captured by the camera 25. Such images include an area G1 that is the upper surface of the basket placing table 38 and an area G2 that is the upper surface of the shopping bag table 39. The first housing 2 and the second housing 3 are omitted in the drawings.

FIG. 4 is a diagram illustrating a state before a registration operation is started. As shown in FIG. 4, in the area G1, a basket K containing items A, B, C and D purchased by a customer is imaged. On the other hand, in the area G2, a temporary placing table 36, an extension bar 37, and a shopping bag F set on the extension bar 37 are imaged. In a state immediately before the start of the registration operation, the item is not stored in the shopping bag F.

FIG. 5 is a diagram illustrating a state immediately after the registration operation is started. In a state immediately after the start of the registration operation, the customer takes out any one of the items stored in the basket K. The camera 25 images the operation of the customer. That is, an operation in which the customer's hand grasps one of the items and takes out the item from the basket K is imaged. Hereinafter, a case in which an item C is taken out will be described as an example.

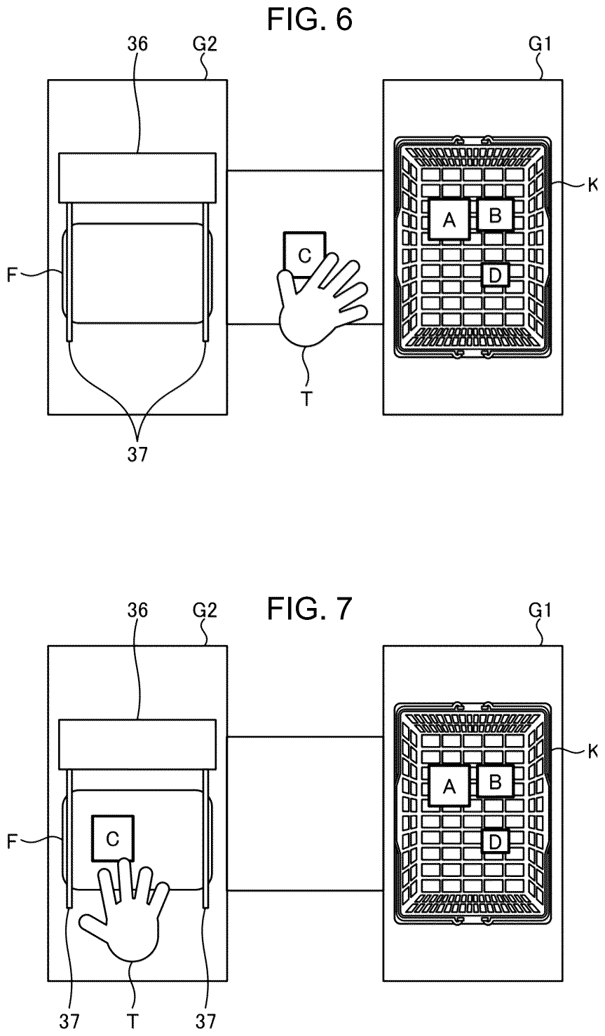

FIG. 6 and FIG. 7 are diagrams illustrating a situation in which the item extracted from the basket K is moved toward the area G2. As illustrated in FIG. 6, when the item C is taken out from the basket K by the customer's hand T, the customer moves the taken-out item C from the area G1 toward the area G2. In addition, the customer bags the item C moved to the area G2 into the shopping bag F. That is, the camera 25 captures an image of the operation in which the hand T of the customer grasps the item C and moves it to the area G2.

When the item C is inserted into the shopping bag F, the RFID antenna 32 provided below the basket placing table 38 communicates with RFID tags attached to the item C, so that the reading unit 101 reads the tag information of the item C. Accordingly, the read item counting unit 103 adds 1 to the read item number. That is, the sales registration process of the item based on the reading of the RFID tag is performed one by one.

On the other hand, the moved item counting unit 104 adds 1 to the moved item count when it recognizes the registration operation by the customer captured by the camera 25, specifically, the operation of moving the item C from the area G1 to the area G2. That is, every time an item stored in the basket K is moved to the shopping bag F, 1 is added to the read item number and the moved item number. A known technique such as an operation recognition technique using an AI can be used, for example, regardless of the method of recognizing the registration operation by the moved item counting unit 104.

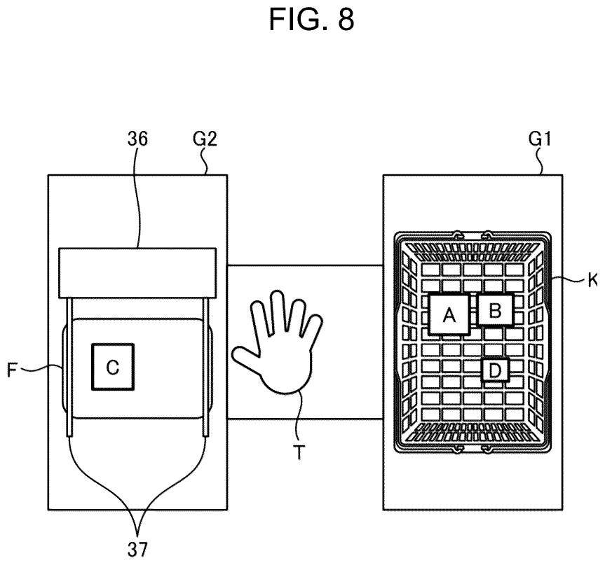

FIG. 8 is a diagram illustrating a state in which the hand T is moved toward the area G1 after the item is placed in the area G2. As shown in FIG. 8, the customer releases his/her hand T from the item C bagged in the shopping bag F, so that the customer's hand T is in a state where nothing is held. Then, the customer moves the hand T from the area G2 toward the area G1 in order to take out the next item from the basket K.

At this time, the camera 25 captures an image of an operation in which the hand T of the customer moves from the area G2 toward the area G1. However, the moved item counting unit 104 holds the moved item number by excluding such an operation from the recognition target or from the counting target of the moved item number.

When the hand T holding the item moves from the area G2 toward the area G1, the moved item counting unit 104 may recognize the operation as a negative operation. In this case, when the moved item counting unit 104 recognizes a negative operation, it subtracts 1 from the moved item number.

Hereinafter, an exemplary item sales data process performed by the self-service POS terminal 1 will be described. FIG. 9 is a flowchart illustrating an exemplary item sales process performed by the self-service POS terminal 1. First, a customer who uses the self-service POS terminal 1 places a basket K containing an item on the basket placing table 38. The customer operates the start key 211 displayed on the display unit 22.

The control unit 100 waits for the start key 211 to be operated (step S11, No), and when it is determined that the start key has been operated (step S11, Yes), starts shooting with the camera 25 (step S12). That is, the camera 25 starts shooting the area G2 including the item in the basket K placed on the basket placing table 38 and the shopping bag F placed on the shopping bag table 39. At this point, no item is stored in the shopping bag F (see FIG. 4). The captured image acquisition unit 102 sequentially stores the images captured by the camera 25 in the image storage unit 142.

Next, the moved item counting unit 104 starts the counting process of the moved item number (step S13). The counting process of step S13 is executed in parallel in the background of the present process. The counting process of step S13 will be described later.

Next, when determining that tag information of an item has been read (step S14, Yes), the reading unit 101 acquires the tag information (step S15). That is, the tag information received by the RFID antenna 32 is acquired via RFID reader 31. Further, while the tag information of the item is not read, the processing waits until the end key 212 is operated (step S14, No->step S19, No).

When the tag information is acquired in the step S15, the read item counting unit 103 adds 1 to the read item number (step S16). Next, the item registration unit 106 performs a sales registration process based on the tag information acquired in the step S15 (step S17). Then, the item information is displayed on the display unit 22 (step S18).

Subsequently, the control unit 100 determines whether or not the end key 212 has been operated, and when it has not been operated (step S19, No), returns the process to step S14. When the control unit 100 determines that the end key 212 has been operated (step S19, Yes), it compares the read item number with the moved item number counted in the counting process of the step S13 (step S20). That is, the read item number counted by the read item counting unit 103 is compared with the moved item number counted by the moved item counting unit 104.

Next, the comparison unit 105 determines whether or not the read item number and the moved item number match with each other based on the process of the step S20 (step S21). Here, when the read item number and the moved item number match with each other (step S21, Yes), the process proceeds to the checkout processing (step S23). When the read item number and the moved item number do not match with each other (step S21, No), it is notified that the numbers do not match with each other (step S22). Note that the notification method and the contents of the message to be notified are not limited to the above-described examples. Further, the control unit 100 returns the process to the step S14 after the discrepancy in the quantity of the step S22 is resolved. Then, the control unit 100 ends the shooting by the cameras 25 (step S24), and ends the screen display by the display unit 22 (step S25).

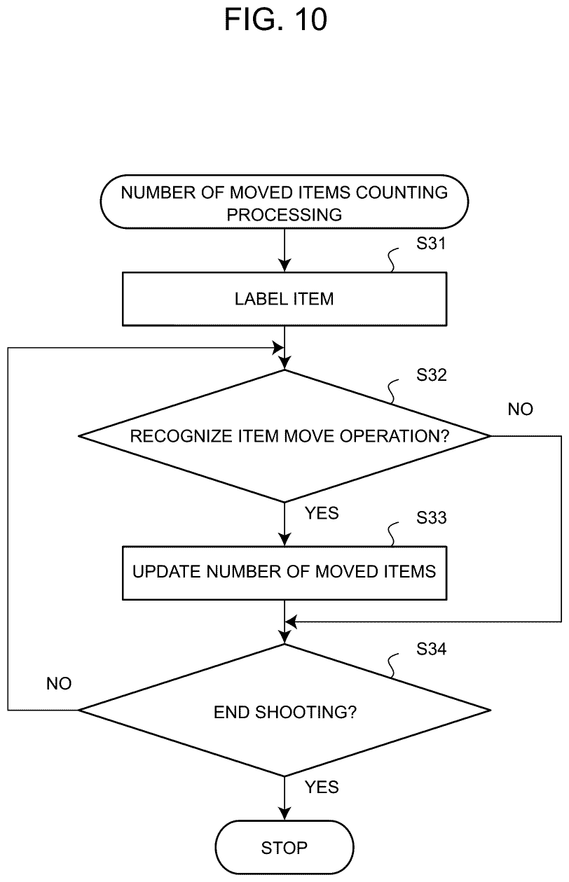

Next, referring to FIG. 10, an exemplary process of counting the moved item number performed by the self-service POS terminal 1 will be described. FIG. 10 is a flowchart illustrating an exemplary process of counting the number of moved items by the self-service POS terminal 1. This process corresponds to the process of the step S13 described with reference to FIG. 9.

First, the control unit 100 labels items included in the displayed images, and distinguishes each item from another item (step S31). Next, the control unit 100 determines whether the item has been moved from the basket K to the shopping bag F (step S32).

Specifically, among the registration operations described above with reference to FIGS. 5 to 7, upon completion of the following two steps: (1) any one of the items stored in the basket K is taken out and (2) the extracted item is moved from the area G1 toward the area G2, the control unit 100 determines that the item has been moved from the basket K to the shopping bag F.

When the item is moved from the basket K to the shopping bag F, that is, when the item registration operation is recognized (step S32, Yes), the control unit 100 updates the moved item number by adding one (step S33). When the moving of the item is not recognized (step S32, No), the control unit 100 skips the step S33 and proceeds to step S34.

Next, the control unit 100 determines whether or not the imaging of the camera 25 has been completed in step S24 of FIG. 9, and returns the process to step S32 if the imaging is continued (step S34, No). That is, the counting processing of the moved item number is continued until the checkout processing is started.

When it is determined that the imaging is completed (S34, Yes), the control unit 100 ends the present process.

As described above, in the self-service POS terminal 1, the number of items to be registered is counted based on the image of an operator who operates the self-service POS terminal 1 and the number of tag information that have been read by the reading unit 101. When the number of items counted based on the read RFID tags and the number of items moved by the operator's registering operation do not match with each other, the operator or the clerk can be notified that the reading of the RFID tags has been performed improperly.

It should be noted that the above-described embodiments can be modified and implemented as appropriate by changing a part of the configuration or function of the above-described apparatus. Therefore, in the following, some modifications according to the above-described embodiments will be described as other embodiments. Note that, in the following, differences from the above-described embodiments will be mainly described, and detailed descriptions of the same points as those described above will be omitted. Further, the modification examples described below may be implemented individually or in combination as appropriate.

### (Modification 1)

In the above-described embodiments, the RFID antenna 32 is installed only below the shopping bag base 39, but the RFID antenna 32 may also be installed below the basket placing table 38. In this case, the read item counting unit 103 merges the tag information read by the RFID antenna 32 of the basket placing table 38 and the tag information read by the RFID antenna 32 of the shopping bag table 39, and counts the number of read items while eliminating the same tag information in which the tag identifiers overlap.

In the configuration of the present modification, since an unspecified number of RFID tags are read at one time, it is preferable that the comparison unit 105 compares the number of read items with the number of moved items at the timing when the end key 212 is operated. Thus, the same effects as those of the above-described embodiment can be obtained.

### (Modification 2)

In the above-described embodiments, when the comparison result of the number of read items and the number of moved items by the comparison unit 105 is inconsistent, the notification unit 108 notifies the customer or the store clerk by displaying a message indicating that the item number does not match on the display unit 22. However, the content to be notified by the notification unit 108 and the conditions for notification are not limited to this.

For example, the notification unit 108 may notify the state of the number of the items by causing the display unit 22 to compare the numbers of the items counted by the read item counting unit 103 with the number of the items counted by the moved item counting unit 104 regardless of the comparison result of the comparison unit 105. Note that the timing displayed on the display unit 22 is not limited to the timing at which the end key 212 is operated, and may be always displayed while the registration operation is performed.

With the above-described configuration, the customer can confirm the number of the item by reading the RFID tag and the number of the item moved by the registering operation, and can more easily recognize that the reading of the RFID tag and the duplicated detection have occurred.

### (Modification 3)

In the above-described embodiments, the counting of the number of moved items is performed by focusing on the operation of the customer himself/herself near the hand T, but the counting method of the number of moved items is not necessarily limited to this. For example, the skeleton or posture of the customer may be estimated from an image captured by the camera 25, and the position of the customer's own hand T may be grasped and used for counting the number of moved items.

With the above configuration, it is possible to improve the accuracy of recognizing the operation related to the item movement, and to accurately count the number of number of moved items, so that it is possible to obtain a more accurate comparison result.

### (Modification 4)

In the above-described embodiments, the comparison between the read item number and the moved item number count by the comparison unit 105 is performed at the timing when the end key 212 is operated, but the comparison timing is not limited thereto. For example, the comparison timing may be a timing at which the tag information of the item is read and the number of read items is updated.

With the above-described configuration, it is possible to notify that an issue has occurred at an early stage when a difference occurs between the number of read items and the number of moved items, and it is possible to more easily recognize that the reading of the RFID tag has been missed or redundantly detected.

### (Modification 5)

In the above-described embodiments, the self-service POS terminal 1 operated by the customer himself/herself has been described as a checkout device, but the present invention is not limited thereto, and the present invention is also applicable to a device that captures and displays an operation of an operator in a checkout device operated by a dedicated operator. In this case, the image captured by the camera 25 is displayed on the display unit 22 for the operator.

### (Modification 6)

In the above-described embodiments, upon completion of the following steps: (1) any one of the items stored in the basket K is taken out and (2) the extracted item is moved from the area G1 toward the area G2, the movement operation is made from the basket K of the item to the shopping bag F. To those steps, the following step can be added: the hand T holding an item enters the shopping bag F and then the hand T not holding anything leaves the shopping bag F.

With the above configuration, it is possible to improve the accuracy of recognizing the operation related to the item movement, and to accurately count the number of number of moved items, so that it is possible to obtain a more accurate comparison result.

The program executed by the self-service POS terminal 1 is provided by being recorded in a computer-readable recording medium such as a CD-ROM, a flexible disk (FD), or a CD-R, a Digital Versatile Disc (DVD) in an installable format or an executable format.

Further, the program executed by the self-service POS terminal 1 may be stored in a computer connected to a network such as the Internet, and may be downloaded through the network. Further, the program executed by the self-service POS terminal 1 may be provided or distributed over a network such as the Internet.

Further, the program executed by the self-service POS terminal 1 may be stored the ROM 12 or the storage unit 14 in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A point of sale (POS) terminal comprising:
a wireless tag reader;
a camera;
a memory; and
a processor configured to:
start a registration process to register items each of which has a wireless tag attached thereto,
control the wireless tag reader to read tag information from one or more wireless tags and store the tag information in the memory,
determine a number of the wireless tags based on the stored tag information,
control the camera to capture one or more images and generate image data from each of the images,
perform object recognition on the image data to determine a number of items shown in the images,
compare the number of the wireless tags with the number of the items,
when the number of the wireless tags is identical to the number of the items, perform a checkout process, and
when the number of the wireless tags is not identical to the number of the items, issue a notification signal.

2. The POS terminal according to claim 1, further comprising:
a display, wherein
the notification signal causes the display to display a screen indicating that the number of the wireless tags is not identical to the number of the items.

3. The POS terminal according to claim 2, wherein the screen shows the number of the wireless tags and the number of the items.

4. The POS terminal according to claim 2, wherein
the processor is configured to determine whether a difference between the number of the wireless tags and the number of the items is greater than or equal to a threshold, and
the notification signal causes the display to display different notifications depending on whether the difference is greater than or equal to the threshold.

5. The POS terminal according to claim 1, further comprising:
an input device, wherein
the processor compares the number of the wireless tags with the number of the items in response to an input of an instruction to start the checkout process via the input device.

6. The POS terminal according to claim 1, further comprising:
a first table on which one or more items that have not been registered are placed; and
a second table on which one or more items that have been registered are placed and under which an antenna connected to the wireless tag reader is disposed, wherein
the camera is positioned to face the first and second tables.

7. The POS terminal according to claim 6, further comprising:
a display between the first and second tables, wherein
the notification signal causes the display to display a screen indicating that the number of the wireless tags is not identical to the number of the items.

8. The POS terminal according to claim 1, further comprising:
a lamp, wherein
the notification signal causes the lamp to emit light.

9. A method performed by a self-service point of sale (POS) terminal that includes a wireless tag reader and a camera, the method comprising:
starting a registration process to register items each of which has a wireless tag attached thereto;
controlling the wireless tag reader to read tag information from one or more wireless tags and storing the tag information in a memory;
determining a number of the wireless tags based on the stored tag information;
controlling the camera to capture one or more images and generating image data from each of the images;
performing object recognition on the image data to determine a number of items shown in the images;
comparing the number of the wireless tags with the number of the items;
when the number of the wireless tags is identical to the number of the items, performing a checkout process; and
when the number of the wireless tags is not identical to the number of the items, issuing a notification signal.

10. The method according to claim 9, further comprising:
in response to the notification signal, displaying a screen indicating that the number of the wireless tags is not identical to the number of the items.

11. The method according to claim 10, wherein the screen shows the number of the wireless tags and the number of the items.

12. The method according to claim 10, further comprising:
determining whether a difference between the number of the wireless tags and the number of the items is greater than or equal to a threshold, and
in response to the notification signal, displaying different notifications depending on whether the difference is greater than or equal to the threshold.

13. The method according to claim 9, wherein the number of the wireless tags is compared with the number of the items in response to an input of an instruction to start the checkout process via an input device.

14. The method according to claim 9, wherein
the POS terminal includes:
a first table on which one or more items that have not been registered are placed, and
a second table on which one or more items that have been registered are placed and under which an antenna connected to the wireless tag reader is disposed, and
the camera is positioned to face the first and second tables.

15. The method according to claim 14, further comprising:
in response to the notification signal, displaying on a display a screen indicating that the number of the wireless tags is not identical to the number of the items, wherein
the display is between the first and second tables.

16. The method according to claim 9, wherein
the POS terminal includes a lamp, and
in response to the notification signal, emitting light from the lamp.

17. A non-transitory computer readable medium storing a program causing a computer to execute a method comprising:
starting a registration process to register items each of which has a wireless tag attached thereto;
controlling a wireless tag reader to read tag information from one or more wireless tags and storing the tag information in a memory;
determining a number of the wireless tags based on the stored tag information;
controlling a camera to capture one or more images and generating image data from each of the images;
performing object recognition on the image data to determine a number of items shown in the images;
comparing the number of the wireless tags with the number of the items;
when the number of the wireless tags is identical to the number of the items, performing a checkout process; and
when the number of the wireless tags is not identical to the number of the items, issuing a notification signal.

18. The computer readable medium according to claim 17, wherein the method further comprises:
in response to the notification signal, displaying a screen indicating that the number of the wireless tags is not identical to the number of the items.

19. The computer readable medium according to claim 18, wherein the screen shows the number of the wireless tags and the number of the items.

20. The computer readable medium according to claim 18, wherein the method further comprises:
determining whether a difference between the number of the wireless tags and the number of the items is greater than or equal to a threshold; and
in response to the notification signal, displaying different notifications depending on whether the difference is greater than or equal to the threshold.
